(19) United States
(12) Patent Application Publication
(10) Pub. No.: US 2003/0236884 A1
(43) Pub. Date: Dec. 25, 2003

(54) Computer system and a method for storage area allocation

(76) Inventors: Yasutomo Yamamoto, Sagamihara (JP); Manabu Kitamura, Yokohama (JP); Takashi Oeda, Sagamihara (JP); Katsunori Nakamura, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/238,772

(22) Filed: Sep. 11, 2002

(30) Foreign Application Priority Data
May 28, 2002 (JP) 2002-153254

(51) Int. Cl. G06F 15/173; G06F 17/30; G06F 7/00

(52) U.S. Cl. 709/225; 707/10

(57) ABSTRACT

It is an object of the present invention to allow storage devices to be used selectively according to the characteristics of each storage device in a computer system where different kinds of storage devices coexist.

Receiving a file system allocation request from the user or an application, a device allocation program on a host sends the request to the storage management server. The storage management server compares the storage configurations of the SAN and NAS systems with the presented requirements for the file system area, selects a storage area which best meets the requirements, reconfigure the storage and returns information about the position of the allocated area to the host. The host, if the allocated area is a file system area, returns the information about the position of the allocated area to the application. If the allocated area is a logical device of the SAN storage, the host makes the operating system recognize the logical device, creates a file system and returns the information about the position of the file system to the application.

### Background of the Invention

The present invention relates to a computer system and a storage device management method in a computer system.

In recent years, storage devices owned by companies or the like have increased both in number and storage capacity with the increased volume of data handled in companies or the like. Consequently, corporate costs for management of the storage devices have swelled.

As a method for reducing the management cost of storage devices, the use of such approaches as the Storage Area Network (SAN) and the Network Attached Storage (NAS) has been proposed. A SAN is a network where a plurality of computers is connected with a plurality of storage devices by using the Fibre Channel (FC) or the Internet Protocol (IP). A NAS is a storage device connected to the IP network.

Existing technologies will drastically increase the number and varieties of storage devices each computer can use via a network. That is, in a computer system where computers are connected with storage devices via a network, a great number of storage devices having different attributes will be connected to the network. Further, it is possible that different kinds of storage devices, such as SAN and NAS devices, will coexist in a computer system. In such a computer system, it will be important to selectively use storage areas, provided by SAN and NAS devices, according to their characteristics.

Disclosed in Japanese Patent Laid-open No. 2001-142648 is a device allocation method in a SAN for determining which device should be allocated to a host computer by taking into consideration the characteristics of the devices connected to the SAN. Practically, the host computer sends a logical device allocation request, combined with attribute requirements in terms of capacity, performance, etc., to a storage management server for the SAN. On the basis the characteristics of each storage device and the required device attributes, the storage management server selects a storage device for allocation. The storage management server instructs the selected storage device to make itself accessible from the host computer which issued the allocation request. Then, the storage management server updates the storage management information held therein and returns information about the allocated device to the host computer which sent the request. In the same publication, a method for allocating a file system from a NAS device is also disclosed.

In the approach disclosed in Japanese Patent Laid-open No. 2001-142648, however, consideration is not given to such a mixed environment as a computer system connected with different kinds of storage device systems. If the above-mentioned technique is applied to an environment where SAN and NAS devices coexist, the host computer side must determine which storage device system, SAN or NAS, should allocate a storage area before issuing an allocation request to an associated storage management server of the selected storage device system. Practically, however, effective allocation of storage areas is impossible without knowledge of the configurations of both SAN and NAS systems because network bandwidth, storage performance and other characteristics differ depending on the specific system.

### SUMMARY OF THE INVENTION

Accordingly, it is an object of the present invention to realize such a storage allocation method in a computer system where both SAN and NAS devices exist that a host computer can be allocated an appropriate storage area only by presenting requirements without the necessity of being aware of the types, configurations, etc. of the storage devices connected to the network.

According to the present invention, in a computer system where different kinds of storage devices coexist, a computer, a storage management computer and storage devices work in cooperation with each other as follows.

At first, the computer sends a request to the storage management computer in order to use a storage area of the storage devices connected to the network. Comparing information about the storage devices connected to the network with the requirements included in the request from the computer, the storage management computer selects a storage device having an storage area which meets the requirements.

The storage management computer sends information about the computer to the selected storage device and information about the selected storage device to the computer. Receiving the information about the selected storage device, the computer controls the storage device on the basis of the received storage device information.

The requirements sent in the request from the computer may include information indicating characteristics and reliability requirements which any storage area to be allocated must satisfy.

In addition, as a preferred embodiment, the computer system may be configured in such a manner that if the selected storage device is a storage device connected to the SAN, the storage management computer instructs the storage device to create a storage area reserved for the computer, and if the selected storage device is a NAS, the storage management computer instructs the NAS to create a file system reserved for the computer.

Further, as another preferred embodiment, the computer system may be configured in such a manner that if the selected storage device is a storage device connected to the SAN, the computer creates a file system in a storage area of the selected storage device on the basis of the information sent from the storage management computer, and if the selected storage device is a storage device connected to the IP network, the computer mounts a file system, which is created in the selected storage device, to its own file system on the basis of the information sent from the storage management machine.

### BRIEF DESCRIPTION OF THE DRAWINGS

FIG. 1 is a block diagram of a computer system according to an embodiment of the present invention;

FIG. 2 is a diagram showing a configuration of a file-accessed storage's configuration management table;

FIG. 3 is a diagram showing a configuration of a block-accessed storage's configuration management table;

FIG. 4 provides a flowchart of file creation processing;

FIG. 5 provides a flowchart of file creation processing by a storage manager;

FIG. 6 provides a flowchart of logical device allocation processing by a storage subsystem;

FIG. 7 provides a flowchart of file system creation processing; and

FIG. 8 is a diagram showing a configuration of a logical device management table.

### DESCRIPTION OF THE PREFERRED EMBODIMENT

An embodiment of the present invention will hereinafter be described. In this embodiment, if a computer receives a file system creation request from an application, it sends a file system creation request, combined with information about the attribute and other requirements which any storage area to be used for the file system must satisfy, to a storage management server, which in turn compares the requirements with the configuration of each storage device and selects a storage device which satisfies the requirements.

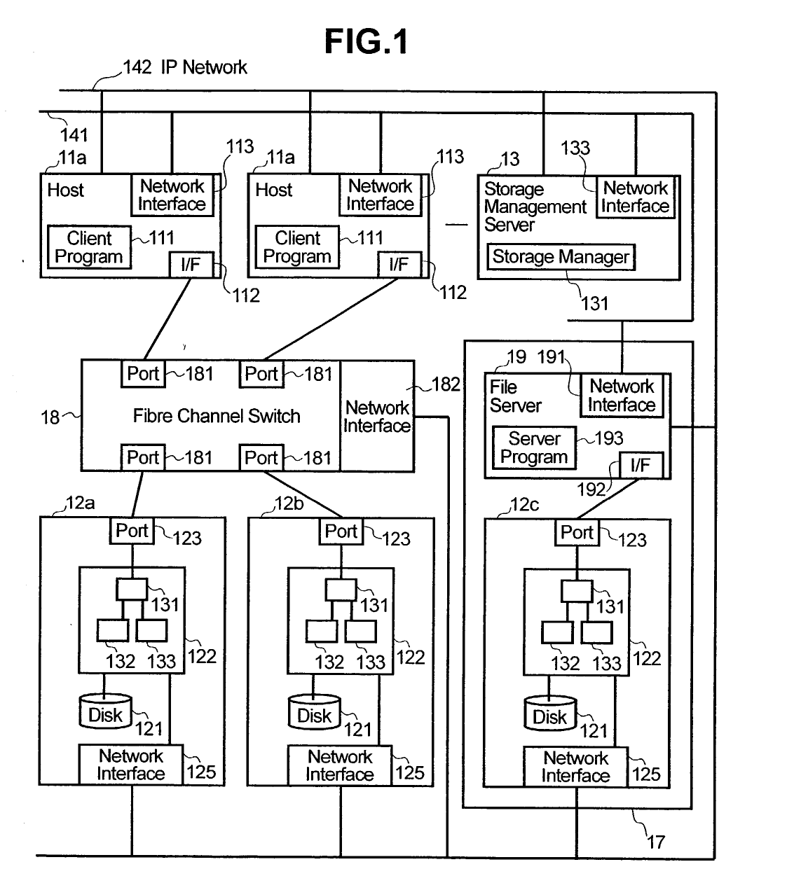

FIG. 1 is a diagram showing a system configuration of a computer system according to this embodiment of the present invention.

In this computer system, a plurality of computers 11a and 11b (hereinafter denoted generically as “host 11”) is connected to storage subsystems 12a and 12b (hereinafter denoted generically as “storage subsystem 12F) via a FC switch 18.

In addition, via an IP network 141, the host 11 is connected with a file server 19 that provides file systems. The file server 19 is connected with a storage subsystem 12c. The file server 19 and the storage subsystem 12c are accommodated in a single cabinet and constitute a NAS 17. In addition, the host 11, the storage subsystems 12F and 12c, the FC switch 18 and the NAS 17 are connected to a management computer (hereafter denoted as “storage management server”) 13 via an IP network 142.

The storage management server 13 retains configuration information gathered from the host 11, the storage subsystems 12F and 12c, the FC switch 18 and the NAS 17 via the IP network 142. In addition, from the FC port address, port WWN and node WWN of each device, the storage management server 13 recognizes the FC network topology indicating the connection states of the individual devices.

The host 11, the file server 19 and the storage management server 13 are computers each provided with a processor comprising a CPU and a memory, not shown. Each of them provides prescribed processing by making the CPU execute the operating system (OS), application programs and so on stored in the memory.

The storage subsystems 12F and 12c (hereinafter denoted generically as “storage subsystem 12”) are storage devices each provided with a plurality of disk units 121, a disk controller 122, a plurality of ports 123 connected to the host 11 or the file server 19, and a network interface 125 connected to the IP network 142.

The storage subsystem 12 in this embodiment provides physical storage areas of the plurality of disk units 121 to the host 11 as one logical storage area (hereinafter denoted as “logical device”) or a plurality of logical storage areas. Note that it is also possible to provide the whole physical storage area of each disk unit as a single logical device to the host 11. Also note that there is no correlation between the number of the disk units 121 in the storage subsystem 12 and the number of logical devices provided by the storage subsystem 12.

In addition, the storage subsystems connected to the SAN and the file server 19 may be replaced by single disk devices. In the following explanation, the use of storage subsystems is assumed.

The port 123 in this embodiment supports the FC interface which implements the SCSI (Small Computer System Interface) as the upper protocol. Note that it is also possible to configure the port 123 so as to support another network interface such as the IP network interface which implement the SCSI as the upper protocol.

The disk controller 122 is provided with a processor 131, a cache memory 132 and a control memory 133. The processor 131 communicates with the host 11 and controls the disk unit 121. In addition, if a plurality of disk units 121 is provided by the storage subsystem 12 to the host 11 as one logical device or a plurality of logical devices, the processor 131 also performs management of relations between the disk units 121 and the logical devices.

The disk controller 122 communicates with the storage management server 13 via the network interface 125. The cache memory 132 temporally stores the data read out from the disk unit 121 and the data received from the host 11. It is possible to operate part of the cache memory 132 as one disk device or a plurality of disk devices in such a manner that the disk unit 121 apparently need not be accessed.

The control memory 133 contains a program which is executed by the processor 131. The control memory 133 also contains the information used for management of the disk unit 121 and the logical devices which are constituted from the disk unit 121.

The host 11 is provided with a network interface 113, a FC interface 112 and a program called a client program 111 in addition to the CPU and the memory mentioned earlier. The host 11 is connected with the FC switch 18 via the FC interface 112. In addition, the host 11 is connected with the file server 19 via the network interface 113.

The client program 111 is a program executed by the host 11 in order to allow application programs running on the host 11 to use logical devices created in the storage subsystem 12F or file systems created in the storage subsystem 12c.

The client program 111 may be integrated into the operating system (not shown) of the host 11. The client program 111 is stored in the memory of the host 111.

The FC switch 18 is provided with a plurality of ports 181 and a network interface 182. Each port 181 is connected to the interface 112 of the host 11 or the port 123 of the storage subsystem 12F. The FC switch 18 is connected to the IP network 142 via the network interface 182.

In this embodiment, all hosts 11 can use all storage subsystems 12F connected to the FC switch 18.

The file server 19 in the NAS 17 is provided with a network interface 191 connected to the host 11 via the IP network 141, an interface 192 connected with the storage subsystem 12c and a server program 193 in addition to the CPU and memory mentioned earlier.

The server program 193 is a program executed by the file server 19 in order to allocate a device in response to a request from the host 11 and provide file access service to the host 11 and others via such a network as a NFS (Network File System).

By executing the server program 193, the file server 19 allows the host 11 to use a file system created in the storage subsystem 12c by the file server 19. In addition, the filer server 19 constructs a file system in the storage subsystem 12c by executing the server program 193.

Incidentally, the storage subsystem 12c and the NAS 17 in this embodiment are treated as one storage subsystem by each host 11. However, the file server 19 and the storage subsystem 12c may be accommodated in separate cabinets.

Although the interface 192 in this embodiment is an interface supporting the SCSI protocol, it may be any interface insofar as the communication protocol with the storage devices is supported.

The storage management server 13 is provided with a network interface 133 to connect each device of the computer system via the IP network and a device manager 131 in addition to the CPU and memory mentioned earlier. The storage manager 131 is a program executed by the CPU of the storage management server 13 in order to manage the storage subsystem 12 connected to the network.

As described so far, this embodiment includes different kinds of storage devices, that is, the storage subsystem 12F having the FC interface and the NAS 17 connected with the host 11 via the IP network.

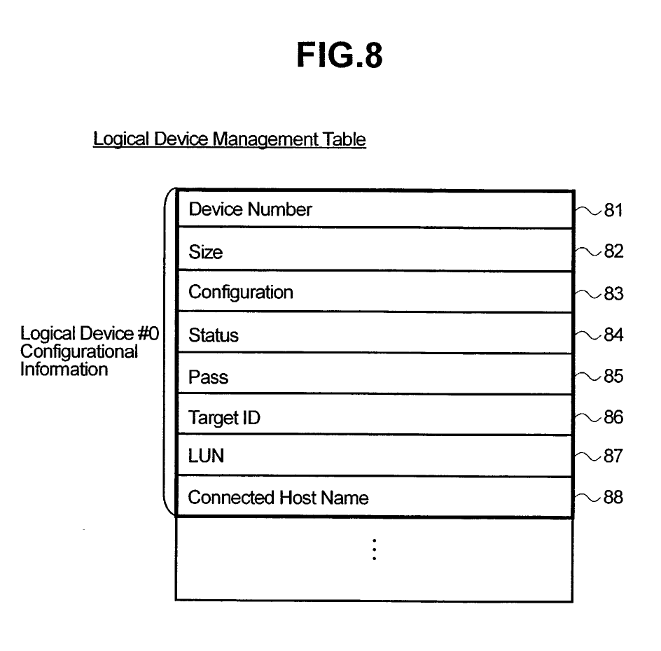

FIG. 8 shows an example of a logical device management table held in the storage subsystem 12 which is connected to the host 11 and the file server 19 (hereinafter denoted generically as “upper host”). The storage subsystem 12 registers logical devices to the logical device management table for management of logical devices provided to the upper host by the storage subsystem 12.

The logical device management table has a logical device number entry 81, a size entry 82, a configuration entry 83, a status entry 84, a bus entry 85, a target ID entry 86, a LUN entry 87 and a connected host name entry 88 for each logical device owned by the storage subsystem 12.

To the logical device number entry 81, information for identifying a logical device provided to the upper host by the storage subsystem 12 is registered. Practically, a unique number assigned to the logical device is registered. To the size entry 82, the capacity of the logical device identified by the logical device number 81 is registered.

To the configuration entry 83, information about the configuration of the logical device is registered. For example, if a RAID consisting of a plurality of disk units 121 is assigned to the logical device, information indicating the RAID type is registered. If a part of the cache memory is assigned to the logical device, information indicating the logical device consists of a “single disk unit” is set to the configuration entry 83.

To the status entry 84, information indicating the status of the logical device is set. The status of each logical device is either “online”, “offline”, “unmounted” or “disabled”. “Online” means that a disk unit 12 associated with the logical device is operating normally in the storage subsystem 12 and the upper host can use the logical device. “Offline” means that the logical device is defined in the storage subsystem 12 but it cannot be used by the upper host. Practically, the logical device is not allocated to any upper host. “Unmounted” means that the logical device is not defined in the storage subsystem 12 and cannot be used by the upper host. “Disabled” means that the logical device is defined in the storage subsystem 12 but the corresponding disk unit is failed and therefore the upper host cannot use the logical device.

Assuming that logical devices are created on the disk unit 121 before the product is shipped from the factory for the sake of simplicity in this embodiment, the status entry 84 for each logical device created in the storage subsystem 12 has the initial value “offline”. Incidentally, the user who uses the storage subsystem 12 can freely create the logical device so that the disk unit 121 in the storage subsystem 12 can be used more effectively.

For example, if the user issues a storage area allocation request to a storage subsystem 12 which is delivered with all logical devices in the “unmounted” status, the storage subsystem 12 defines one or more disk units 121 as a logical device which satisfies the requirements. Practically, on the basis of the information about the unused areas of the disk units 121 and the performance and other characteristics management information about each disk unit 121, the storage subsystem 12 selects one or more disk units 121 which satisfy the user's requirements. Then the storage subsystem 12 registers the logical device, which is assigned storage areas of the selected disk units 121, to the logical device management table.

The bus entry 85 indicates which of the ports 123 is logically connected to the logical device. Each port 123 is assigned a unique number in the storage subsystem 12. To the bus entry, the number of the port 123 connected to the logical bus is registered.

To the target ID entry 86 and the LUN entry 87, information or identifiers used by the host 11 to identify the logical device are registered. Here, information indicating SCSI-ID and LUN, identifiers used in the SCSI protocol are registered to the respective entries. It is also possible to register identifiers used in another protocol as the case may be.

The connected host name entry 88 is used only by the storage subsystem 12F having the FC interface. The connected host name entry 88 specifies which host 11 is permitted to use the logical device, that is, to read data from or write data to the logical device. Practically, information indicating a host name is registered to identify one of the hosts 11.

Any value, such as a world wide name (WWN) which is generally given to the I/F 112 of each host 11, can be used as a host name if the value can designates a specific host 11 or the interconnection interface of a specific host 11. Note that the connected host name entry 88 may be omitted from the logical device management table held by the storage subsystem 12c.

Further, the storage subsystem 12 retains management information such as logical-to-physical associative information indicating associations between logical storage areas and physical storage areas, or between logical devices and disk units 121. If the storage subsystem 12 is a RAID device, the logical-to-physical associative information includes the identifier and capacity of the disk unit 121 constituting the logical device. If a plurality of logical devices is defined in one RAID, the information includes the starting location of each logical device in the RAID. If a plurality of RAIDs constitutes one logical device, the information includes the order of the RAIDs.

The file server 19 has the same logical device configuration management table as that of the storage subsystem 12c in order to manage the allocation of logical devices provided by the storage subsystem 12c.

In this embodiment, the storage management server 13 gathers information about the configuration of every storage subsystem in the computer system and retains the information as a file access storage configuration management table or the like.

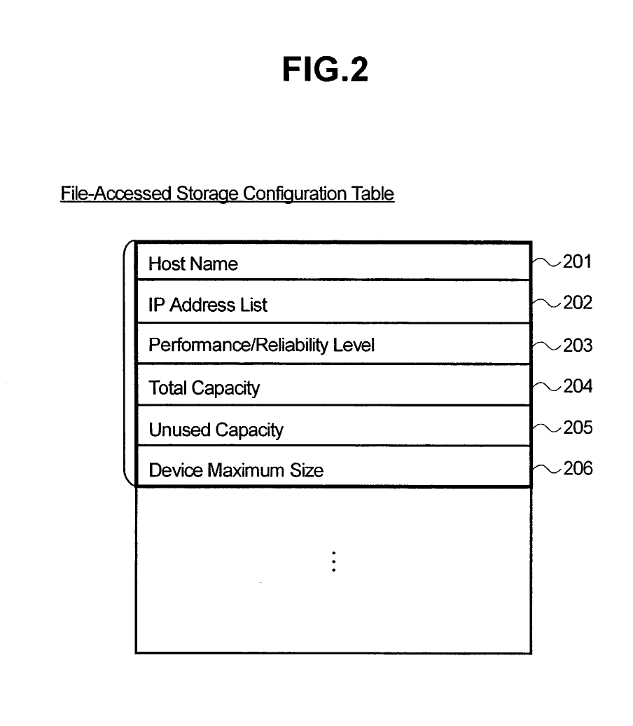

FIG. 2 shows a configuration of a file-accessed storage's configuration management table retained by the storage management server 13. Stored in the file-accessed storage's configuration management table is information used by the storage management server 13 for the management of the storage subsystem 12c owned by the NAS 17.

For each NAS 17, the file-accessed storage's configuration management table has a host name entry 201, an IP address list entry 202, a performance/reliability level entry 203, a total capacity entry 204, an unused capacity entry 205 and a device maximum size entry 206.

To the host name entry 201, information indicating the host name of the file server 19 is registered. Generally, an arbitrary host name is given to the file server 19 by the user. On the IP network, the relation between the IP address and the host name given to the file server 19 is managed by a DNS (Domain Name Server).

To the IP address list 202, one or more IP addresses owned by the network interface 191 of the file server 19 are registered. The registered IP addresses are used as destination addresses for communication when the host 11 accesses the file server 19 (NAS 17). If the file server 19 is connected to the IP network 141 via a plurality of network interfaces 191, the IP address entry 202 indicates the IP addresses assigned to each of the plurality of network interfaces 191.

To the other entries, information about the attributes of the NAS 17 comprising the file server 19 and the storage subsystem 12c is registered by the storage management server 13.

The performance/reliability level entry 203 retains evaluative values given objectively, on the basis of the computer system, to the performance and reliability of the storage subsystem 12c.

The performance evaluation indexes may include the seek and rotation speeds of the disk unit 121 mounted in the storage subsystem 12c, the storage capacity of the disk unit 121, the RAID level configured in the storage subsystem 12c, the communication bandwidth between the controller 122 and the disk unit 121, the communication bandwidth of the port 123, the number of communication lines, the storage capacity of the cache 132, the nominal, total performance values of the storage subsystem 12c, the performance of the processor owned by the file server 19, the number of processors, the transmission bandwidth of the network interface 191, and the number of interfaces.

The reliability evaluation indexes may include the redundancy of elements constituting the disk unit 121 and the disk controller 122 in the storage subsystem 12c, the RAID level implemented in the storage subsystem 12c, the number of available alternative paths and other various configurational conditions subject to product specifications.

Although it is assumed in this embodiment that the requirements presented by the host 11 in a request to allocate a logical device concern performance and reliability, it is also possible to include functional requirements or criteria owned by each storage subsystem. For example, such functions as to replication and backup of logical devices, provided by the file server 19 and the storage subsystem 12, can be taken into consideration.

The total capacity entry 204 registers information indicating the total of available storage areas in the storage subsystem 12c. This total available capacity is determined by the storage capacity of each disk unit 121 owned by the storage subsystem 12c, the number of such disk units 121 and the RAID level implemented in the storage subsystem 12c. In this embodiment, since it is assumed that available logical devices are predetermined, the total capacity of the available logical devices is registered to this entry.

The unused capacity entry 205 registers information indicating which logical devices owned by the storage subsystem 12c are not yet allocated to the host 11. In this embodiment, since the logical devices in the “unmounted” state cannot be used by the host 11, the total storage capacity of the logical devices in the “offline” state is registered to this entry.

The device maximum size entry 206 registers information indicating the storage capacity of the largest logical device the storage subsystem 12c can create therein. Of the logical devices in the “offline” state, the size of the largest one is registered to this entry.

This embodiment where all logical devices are already defined may be modified in such a manner that the storage subsystem 12c can define a logical device in response to a request from the host. In such an embodiment, information indicating the total capacity of the unused storage areas of the disk units 121 may be registered to the unused capacity entry 205. Further, in such an environment, the capacity of the largest logical device which can be created by using the unused areas of the disk units 121 within the limits of control by the storage subsystem 12 may be registered to the device maximum size entry 206. The limits of control mean, for example, the maximum allowable number of disks in a disk array per logical device and the maximum allowable size of control information relative to a capacity per logical device.

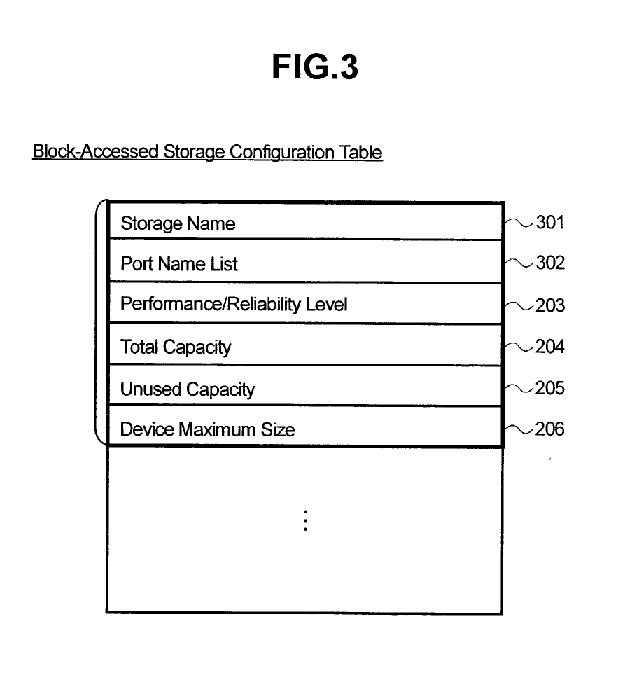

FIG. 3 is a block-accessed storage's configuration management table owned by the storage management server 13.

To the block-accessed storage's configuration management table, information used by the storage management server 13 to manage the storage subsystem 12F is registered.

The block-accessed storage's configuration management table has a storage name entry 301, a port name list entry 302, a performance/reliability level entry 203, a total capacity entry 204, an unused capacity entry 205 and a device maximum size entry 206.

To the storage name entry 301, information about an identifier for identifying one of the storage subsystems 12F is registered. For example, the identifier may be the fiber channel's platform WWN or a combination of the vendor's identifier and product number owned by the storage subsystem 12F.

To the port name list entry 302, information indicating the WWN assigned to the port 123 owned by the storage subsystem 12F is registered. As mentioned above, the port name (WWN) is used as an identifier by which the host 11 can identify the port of the storage subsystem 12F as the destination.

Information registered to the performance/reliability level entry 203, the total capacity entry 204, the unused capacity entry 205 and the device maximum size entry 206 is the same as the information registered to those in the file-accessed storage's configuration management table.

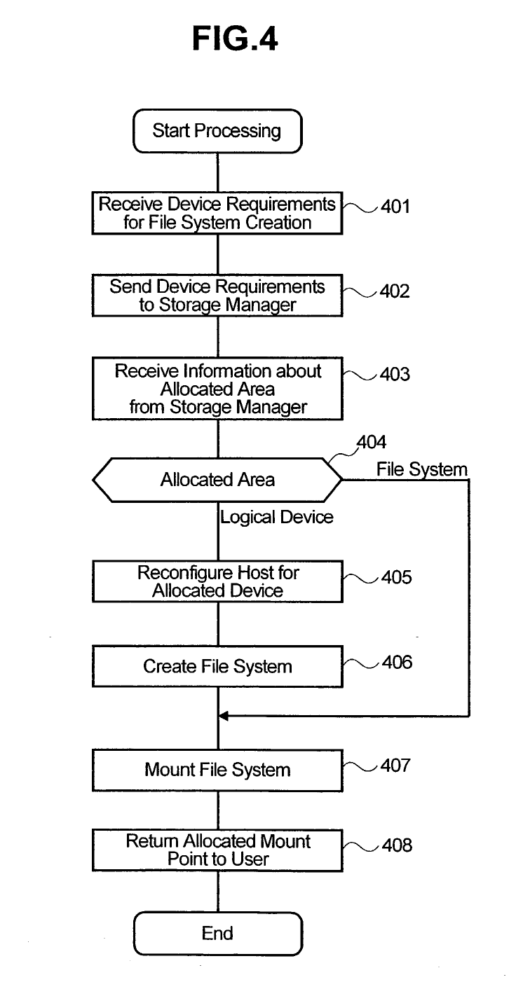

FIG. 4 is a flowchart of file system creation processing by the client program 111. This processing is performed by the host 11 through the client program 111 in response to a request to create a new file system issued from, for example, an application program running on the host 11.

The new file system creation request received by the client program 111 from the user, the application program or the like is accompanied with requirements for the size and attribute of the file system to be created, the storage capacity of the storage area in which the file system is to be created, and the performance and reliability of the logical device for the file system.

The size of the storage area, mentioned above, means the size of a logical device described earlier. Information about the performance and reliability requirements indicates objective performance/reliability any logical device to be selected for the file system must meet on the basis of the criteria in the computer system described above.

The performance requirements may concern such an aspect of performance as the access speed of the logical device by assuming a low speed disk drive, a high speed disk drive, a cache-resident disk or the like.

The reliability requirements may include such configurational requirements for the logical device as a certain RAID level, dual path and remote mirror.

Dual path allows the host 11 to access the same device via a plurality of interfaces in the case where the host 11 has a plurality of interfaces. Even when a path cannot be used, the device can be accessed via the other path (alternative path).

The remote mirror generates a copy of a logical device owned by a storage subsystem 12 in another storage subsystem 12. Reliability of the computer system can be raised because even when the storage subsystem 12 fails due to an earthquake, a fire or the like, the data copy held by the remote storage subsystem is available (Step 401).

The client program 111 sends a file system creation request to the storage management server 13 and waits for a response (Step 402).

From the storage management server 13, the client program 111 receives information about the allocated storage area.

The received information indicates whether the allocated storage area is a logical device owned by a storage subsystem 12F or a file system provided by the file server 19. In addition, the received information includes information necessary to access the logical device or the file system. For example, in the former case, the information includes the logical device's WWN and LUN assigned to the port 123 of the storage subsystem 12. In the latter case, the information includes the host name or IP address of the file server 19 and the directory name of the file system if the NFS protocol is implemented (Step 403).

Using the received information, the client program 111 judges whether the allocated storage area is a logical device owned by the storage subsystem 12F or a file system provided by the file server (Step 404).

If the allocated storage area is a logical device of the storage subsystem 12F, the host 11 reconfigures itself so that it can use the logical device. Practically, this reconfiguration is done as follows:

The host 11 is assumed to be running under what is called an open operating system. Therefore, for the host 11 to use logical devices, a device file is prepared for each logical device. Device files are prepared when device configuration recognizing processing is done by the host 11. Thus, logical devices have no device files if they didn't exist when the last device configuration recognizing processing was done. Due to this, a device file must be prepared in the host 11 for the newly allocated logical device in this step.

More practically, Hewlett-Packard's operating system uses the “IOSCAN”; command to recognize new logical devices and create device files for them. As a result of the device configuration recognizing processing like this, the host 11 gets able to use the newly allocated logical device (Step 405).

Once the newly allocated logical device gets available, the host 11 creates a file system, concretely a directory, in the logical device (Step 406). Then, the host 11 mounts the file system, in other words, concatenates the new file system to the existing directory tree (Step 407). After that, information indicating the mount point is sent back by the client program 111 to the application program or the like (Step 408).

Meanwhile, if the storage area allocated by the storage management server is a file system provided by the file server 19, steps 407 and 408 are performed in order to make the provided file system available (Steps 407 and 408).

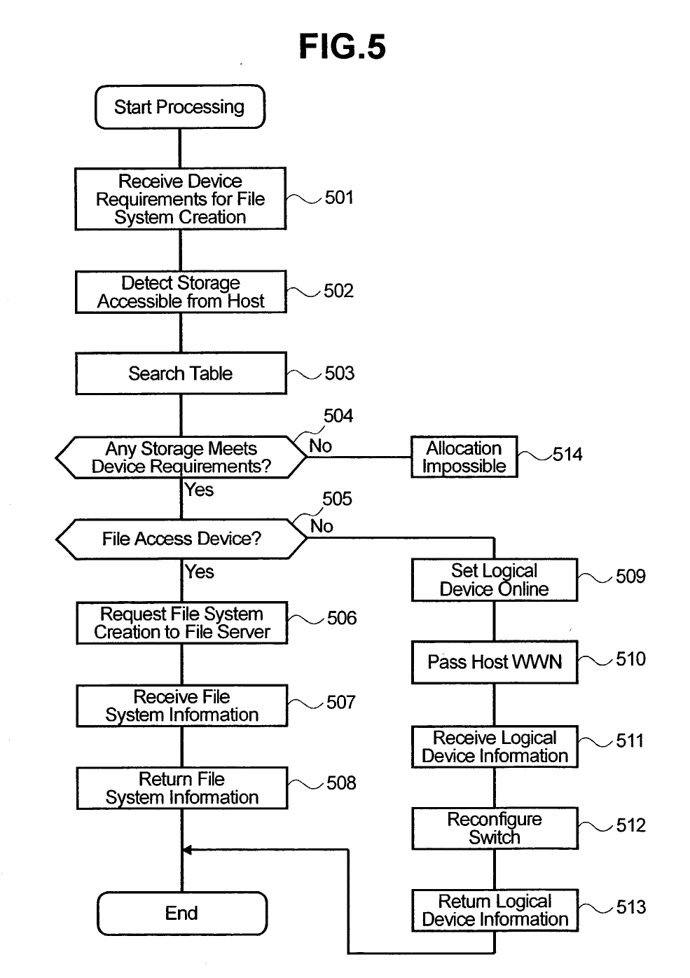

FIG. 5 is a flowchart of file system creation processing by the storage management server 13. Receiving a file system creation request from the host 11, the storage management server 13 performs this processing by executing the storage manager 131.

The storage management server 13 receives from the host 11 the file system creation request that includes information about what characteristics are required of the file system to be created and the logical device in which the file system is to be created (hereinafter denoted as “device requirements”(Step 501).

The storage management server 13 selects storage subsystems 12 which can be accessed by the host 11 which has issued the file system creation request (hereinafter denoted as requester host 11”) via the FC or the IP network. To make this selection, the storage management server 13 requires information about the configuration of the network connecting the hosts 11 and the storage subsystems 12.

Practically, this selection is made by using the FC network topology prepared on the basis of configurational information gathered by the storage management server 13 from each device and the zoning information which is set to the fibre channel switch 18. Even if the I/F 112 of a host 11 is connected to a port 123 of a storage subsystem 12F via the fiber channel, the host 11 is judged as not accessible to the storage subsystem 12F if access between the two ports is prohibited due to the zoning. Detail of the zoning information is not explained here because this information is retained by most storage management servers (Step 502).

Then, from the storage subsystems 12 selected in step 12, the storage management server 13 chooses a storage subsystem 12 which meets the device requirements presented by the requester host 11. Practically, the storage management server 13 compares the file/block-accessed storage's configuration table held therein with the device requirements contained in the file system creation request and determines a storage subsystem 12 which meets the device requirements (Steps 503 and 504).

If any of the storage subsystems 12 does not meet the device requirements, the storage management server 13 notifies the requester host 11 that no device cannot be allocated and terminates the processing (Step 514).

If a storage subsystem 12 exists which meets the device requirements, the storage management server 13 determines the type of the storage subsystem 12 to be allocated (Step 505).

If the storage subsystem 12c is to be allocated, the storage management server 13 sends a file system creation request to the file server 19, including the device requirements received from the requester host 11 (Step 506). Then, from the file server 19, the storage management server 13 receives information about the file system to be allocated (Step 507). The storage management server 13 also sends information about the file system to the requester host (Step 508).

If a storage subsystem 12F is to be allocated, the storage management server 13 instructs the selected storage subsystem 12F to set its logical device “online” with the requester host 11 (hereinafter, referred to as “online instruction”). This online instruction sent to the storage subsystem 12F also includes the device requirements received from the requester host 11 (Step 509).

In addition, the storage management server 13 instructs the selected storage subsystem 12F to reconfigure itself so that a logical device owned by the selected storage subsystem 12F can be used by the requester host 11. Practically, the storage management server 13 sends information indicating the WWN assigned to the interface 112 of the requester host 11 to the selected storage subsystem 12F and instructs the storage subsystem 12F to allow accesses through the interface 112. (Step 510)

Receiving information about the allocated logical device from the storage subsystem 12F (Step 511), the storage management server 13 instructs the FC switch 18 to change its zoning so as to allow the logical device to be accessed through the interface 112 of the requester host 11. The logical device information sent from the storage subsystem 12F includes the WWN assigned to the port 123 of the storage subsystem 12F and the LUN which allows the port 123 to identify the logical device (Step 512).

Then, the storage management server 13 sends the logical device information received from the storage subsystem 12F to the requester host 11 (Step 513).

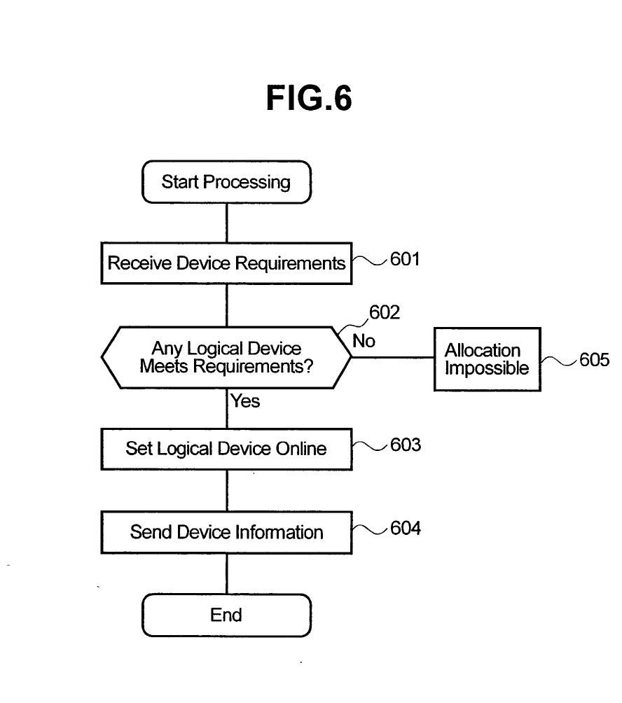

FIG. 6 is a flowchart of logical device allocation processing by a storage subsystem 12F. This processing is executed by the storage subsystem 12F when a logical device allocation request is received from the storage management server 13.

Receiving a logical device allocation request from the storage management server 13, the storage subsystem 12F searches the logical device management tables for an offline logical device which meets the received device requirements (Step 601 and Step 602).

If no logical device does not exist which meets the device requirements, the storage subsystem 12F notifies the storage management server 13 that it cannot allocate a logical device and terminates this allocation processing (Step 605).

If a logical device exists which meets the device requirements, the storage subsystem 12F changes the status entry 8 in the corresponding logical device management table to “online”and defines the LUN to the port 123 reachable from the interface 12 of the requester host 11. In addition, the storage subsystem 12F registers the received requester host's WWN to the connected host name entry 88 of the logical device management table so as to allow the requester host 11 to access the allocated logical device via the interface 112 of the requester host (Step 603). Then, logical device information about the allocated logical device is sent to the storage management device (Step 604).

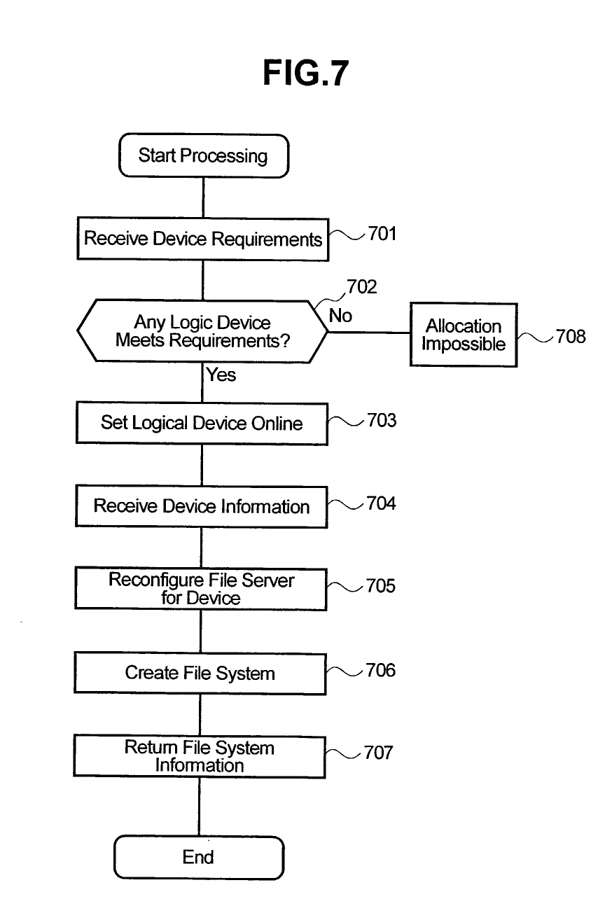

FIG. 7 is a flowchart of file system creation processing the file server 19 performs by executing the server program 193. This processing is executed when a file system creation request is received from the storage management server 13.

Receiving a file system creation request and device requirements from the storage management server 13, the file server searches the logical device management tables for an offline logical device which meet the received device requirements (Steps 701 and 702). If no logical device does not exist which meets the device requirements, the file server 19 notifies the storage management server 13 that it cannot create a file system and terminates this allocation processing (Step 708).

If a logical device exists which meets the device requirements, the file server 19 instructs the storage subsystem 12c to set the logical device “online” (Step 703).

Receiving logical device information about the logical device, which is set online as above, from the storage subsystem 12c (Step 704), the file server 19 reconfigures itself so as to make the logical device of concern available from the file server 19 (Step 705). Then, the file server 19 creates a file system in the logical device (Step 706) and sends information about the created file system to the storage management server 13 (Step 707). Explanation of Steps 705 and 706 is omitted here because these steps can be implemented in the same manner as Steps 405 and 406 in FIG. 4.

Implementation of the present invention is not limited to the embodiment described so far. A number of variations are possible within the scope of the present invention.

For example, instead of selecting a logical device of concern on the basis of the performance/reliability level information about each storage subsystem 12 included in the block-accessed storage's/file-accessed storage's configuration information held by the storage management server 13, the computer system can be configured in such a manner that the storage management server 13 receives logical device configuration information from the storage subsystems 12 each time the configuration is changed and determines the performance/reliability level of each storage subsystem 12 on the basis of the received information.

While such an embodiment increases communication between the storage management server 13 and the storage subsystems 12 and therefore may impose substantial loads on the server and the network, it has such advantages that the latest information about the logical device configuration can be obtained and the storage server 13 need not install a memory to retain the configurational information about all logical devices.

It is also possible to configure the computer system in such a manner that the storage management server 13 selects some candidate storage subsystems 12 for allocation on the basis of the performance/reliability level and other evaluation values the storage management server 13 retains about each storage subsystem 12, sends the file system allocation request from the host 11 to each of the selected storage subsystems 12, each selected storage subsystem 12 selects some candidate logical devices for allocation and the storage management server 13 finally selects a logical device for allocation from those candidate logical devices.

In addition, while the logical device allocation method is described so far based on the assumption that the states of the storage subsystems 12 are static, it is possible to realize more appropriate logical device allocation in terms of performance, etc. by taking into consideration the dynamically changing states of the storage subsystems 12 during operation of the computer system.

For example, what should dynamically be evaluated may include the load on the network when a storage subsystem 12 is accessed, the occupancy rates of the port 123, the controller 122 and the disk unit 121 in the storage subsystem 12, and the occupancy rate of the cache in the controller 122. Accordingly, the computer system can be configured in such a manner that the storage management server 13 retains information about the current load on each storage subsystem 12, which is evaluated comprehensively according to criteria prescribed by the computer system's administrator, user, etc., and selects a logical device on the basis of this information. Further, each storage subsystem 12 can be configured in such a manner that selection of a logical device within the storage subsystem 12 is made by taking into consideration the internal dynamic status information the storage subsystem 12 retains.

According to the present invention, it is possible to use storage devices having appropriate characteristics in a computer system where different kinds of storage devices coexist.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A storage device selecting method in a computer system comprising different kinds of plural storage devices, a computer connected with the plural storage devices and a management computer connected with the plural storage devices and said computer, said method comprising the steps of:
transmitting a request to use a storage area owned by some of the plural storage devices to said management computer from said computer connected with the plural storage devices;
comparing information about the plural storage devices with the requirements included in the request from said computer connected with the plural storage devices, selecting a storage area which meets the requirements from the plural storage devices, and transmitting information about a storage device having the selected storage area, wherein these operations are implemented by said management computer; and
receiving the information about the storage device and controlling the storage device on the basis of the received information, wherein these operations are implemented by said computer connected to the plural storage devices.

2. A method according to claim 1, wherein said request includes information about performance of the storage area to be used by said computer connected to the plural storage devices.

3. A method according to claim 2, wherein said plural storage devices include a first storage device having the Fibre Channel interface and a second storage device having the Internet Protocol network interface.

4. A method according to claim 3, wherein said second storage device comprises a file system management computer and a storage device containing a file system.

5. A method according to claim 4, further comprising the step of controlling the selected storage device by said management computer so that the selected storage device can be used by said computer connected to the plural storage devices.

6. A method according to claim 5, wherein if the selected storage device is the first storage device, said management computer instructs the first storage device to create a storage area for said computer, and if the selected storage device is the second storage device, said management computer instructs the file system management computer of the second storage device to create a new file system.

7. A method according to claim 6, wherein if the received information is information indicating the first storage device, said computer creates a file system in the storage area created in the first storage device, and if the received information is information indicating the second storage device, said computer mounts the file system created in the second storage device.

8. A management computer connected with a computer and plural storage devices, comprising;
a control unit; and
an interface used to connect said computer and the plural storage devices;
wherein, the control unit, via the interface, receives a request from said computer to use a storage area owned by some of the plural storage devices;
compares the configurations of the plural storage devices with the storage area requirements included in the request and selects a storage area which meet the requirements; and
transmits information about the storage device containing the selected storage area to said computer via the interface.

9. A management computer according to claim 8, wherein the plural storage devices each include a first storage device having an interface supporting the Fibre Channel and a second storage device having an interface supporting the Internet protocol.

10. A management computer according to claim 9, further comprising a memory for recording information about the configurations of the plural storage devices.

11. A computer system comprising:
a first computer;
a first storage subsystem connected with the first computer;
a file server connected with the first computer;
a second storage subsystem connected with the file server; and
a second computer connected with the first storage subsystem, the first computer and the file server;
wherein, the first computer sends a file area creation request to the second computer, and the second computer, in response to the file area creation request sent from the first computer, determines a storage device for file area creation in the first storage subsystem or the second storage subsystem.

12. A computer system according to claim 11, wherein if the determined storage device is included in the first storage subsystem, the second computer reconfigures the first storage subsystem so that the determined storage device can be accessed from the first computer and transmits information about a position of the determined storage device to the first computer.

13. A computer system according to claim 11, wherein if the determined storage device is included in the second storage subsystem, the second computer requests the file server to create a file area, received information about a position of the created file area and transmits the information about the position of the file area to the first computer.

14. A computer system according to claim 13, wherein the information transmitted from the second computer to the first computer includes information indicating whether the allocated storage area is a storage device or a file area.

15. A computer system according to claim 14, wherein the first computer judges whether the storage area designated by the second computer is a storage device or a file area.

16. A computer system according to claim 15, wherein if the first computer judges that the allocated storage area is a storage device, the first computer reconfigures the first computer itself so that the storage device can be used by the first computer and creates a file area in the storage device.

17. A computer system according to claim 16, wherein if the first computer judges that the allocated storage area is a file area, the first computer reconfigures the first computer itself so that the file area can be used by the first computer
